(19) United States
(12) Patent Application Publication
(10) Pub. No.: US 2014/0189885 A1
(43) Pub. Date: Jul. 3, 2014

(54) PERMITTING A USER ACCESS TO PASSWORD PROTECTED DATA

(71) Applicant: MICROSOFT CORPORATION, Redmond, WA (US)

(72) Inventor: Alon Golan, Sunnyvale, CA (US)

(73) Assignee: Microsoft Corporation, Redmond, WA (US)

(21) Appl. No.: 13/728,545

(22) Filed: Dec. 27, 2012

(51) Int. Cl. G06F 21/62; G06F 21/31

(52) U.S. Cl. CPC G06F 21/62; G06F 21/31
USPC 726/28

(57) ABSTRACT

A method of permitting a user access to password protected data at a device, the user associated with a first and second password, wherein the passwords are of the same format, and entry of the first password requires less user input actions than are required for entry of the second password, the method comprises a user interface component of the device requesting from the user, entry of the first password; in response to receiving an entry entered by the user using said device, processing the user entry in a password verifying component of the device to compare the user entry with the first password associated with the user; if no user entry matches the first password in a predetermined number of attempts permitted by the password verifying component, the user interface component requests from the user, entry of the second password.

### BACKGROUND

Within a computer system maintaining the security of information and access to that information is of particular importance. A common method for maintaining security in computer systems is through associating a user-specific password with a particular user and requiring the user to submit the password to receive access to password protected information within the computer system.

A password can take the form of a string of characters, a password that provides strong security is typically a minimum of 6-8 characters in length and includes a combination of upper case letters, lower case letters, numbers and symbols. It is common for users to have many different passwords, each of which is associated with a different username and a different application, program or website. This can make it difficult for a user to remember all the different usernames and passwords that are associated with all the different application programs, accounts, and websites that the user uses. This can result in a user repeatedly entering an incorrect password when attempting to access password protected data.

Due to the length of passwords that provide strong security many users keep track of their username and passwords by writing them on a piece of paper or by entering them in a word processor file in their electronic device. However it will be apparent that by storing the username and passwords in this way, the username and passwords may be accessed by an unauthorized user.

Microsoft's Internet Explorer™ comprises a web form “auto-complete” feature. Using this feature, users can automatically complete or fill-in fields in web forms based on previously defined data which is stored by Internet Explorer on a user's local computer. This feature can be used to memorize and enter a password field in a website form, thereby relieving the user of having to remember the password for that form or website. However, any person who has access to the user's electronic device, and therefore access to the user's auto-complete memorized data file, may use Internet Explorer™ to auto-complete a form, such as a log-on sequence, and subsequently access the user's online accounts and files.

### SUMMARY

The inventor has realised that users are usually torn between using a strong password and using a password that is easy to remember and/or type. This is especially valid on smaller devices where typing is less convenient. The methods described herein allow users to use a strong password while keeping their day-to-day login use less impacted.

There is provided a method of permitting a user access to password protected data at a device, the user associated with a first password and a second password, wherein the first and second password are of the same format, the method comprising: a user interface component of the device requesting from the user, entry of the first password; in response to receiving an entry entered by the user using said device, processing the user entry in a password verifying component of the device to compare the user entry with the first password associated with the user; if the password verifying component determines that the user entry matches the first password associated with the user, the password verifying component controlling the user interface component to permit the user access to the password protected data.

The password verifying component permits a predetermined number of attempts at entry of the first password and if no user entry matches the first password in the predetermined number of attempts, the method further comprising: the user interface component of the device requesting from the user, entry of the second password; in response to receiving a new entry entered by the user using said device, processing the new entry in the password verifying component of the device to compare the new entry with the second password associated with the user; and if the password verifying component determines that the new entry matches the second password associated with the user, the password verifying component controlling the user interface component to permit the user access to the password protected data. Entry of the first password requires less user input actions than are required for entry of the second password.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section

### BRIEF DESCRIPTION OF THE DRAWINGS

For a better understanding of the described embodiments and to show how the same may be put into effect, reference will now be made, by way of example, to the following drawings in which:

FIG. 1a illustrates a communication system;

FIG. 2 illustrates a user device;

FIG. 3 is a flow chart for a process of permitting a user access to password protected data;

FIGS. 4a and 4b shows user entry dialogue boxes.

### DETAILED DESCRIPTION

Embodiments of the invention relate to permitting a user access to password protected data. The user is associated with two passwords, an account password (the password that the user would conventionally enter to access the password protected data) and an additional password (also referred to as a “password simplifier” herein).

In embodiments of the invention, entry of the password simplifier provides a simpler way for a user to access password protected data compared to entry of the account password.

Passwords can take many forms. In one embodiment, the account password and password simplifier may consist of a number of characters, the password simplifier having fewer characters than the account password. For example, the number of characters of the account password may be equal to, or greater than six, whereas the number of characters of the password simplifier may be equal to, or less than three.

The characters of the account password and password simplifier may include one or more of the following: one or more lower case letter; one or more upper case letter; one or more number; and one or more symbol. Due to the fact that the additional password has fewer characters than the account password, the additional password is easy for the user to remember and type.

Using a keyboard, the additional password can be set using one or more of the 95 printable characters defined in the American Standard Code for Information Interchange (“ASCII”) character-encoding scheme. The 95 printable characters represent letters (upper case and lower case), digits, punctuation marks, and some miscellaneous symbols.

It is normally considered that short simple passwords are easy to guess. However, in the method described herein the user is only given a single or very few attempts at entry of the additional password. When you only have one or very few attempts, even a one character password is difficult to guess.

As an example, if the additional password is a single ASCII printable character and only a single attempt at entering the additional password is provided to the user, an unauthorized user has approximately a 1% chance of gaining unauthorized access to the application, program or website. It will be apparent that by increasing the number of characters of the additional password (for example to two or three ASCII printable characters), the chance of an unauthorized user gaining unauthorized access to the application, program or website is considerably lower.

It will be appreciated that the character set for the account password and additional password should not be limited to ASCII, other character sets may be used for the account password and additional password. For example, a Unicode character set, which has just over 1.1 million characters, may be used.

A user is first asked for the additional password. If the user does not enter the additional password in the number of allowed attempts, the user is asked to enter their account password. The user is unable to subsequently login with the additional password until the account password has been correctly entered.

It will be appreciated that the password protected data can take many forms. For example, the password protected data may be data of an operating system executed on a processor of a device, data of a website accessed on a device, or data of an application (for example a communication client application) executed on a processor of a device.

A first embodiment is now described by reference to a user logging-in to a communication client application. This example is used to merely illustrate how the methods described herein can be implemented and it will be appreciated that the methods described herein can be applied to any system in which a user must enter a password to access data.

Packet-based communication systems allow the user of a device, such as a personal computer, to communicate across a computer network such as the Internet. Packet-based communication systems include voice over internet protocol (“VoIP”) communication systems which can support calls between users of the communication systems. These systems are beneficial to the user as they are often of significantly lower cost than fixed line or mobile networks. This may particularly be the case for long-distance communication. To use a VoIP system, the user must install and execute client software on their device. The client software is provided by a software provider. The client software provides the VoIP connections as well as other functions such as registration and authentication. That is, a user is able to register an account with the software provider using the client software by setting up a username and account password.

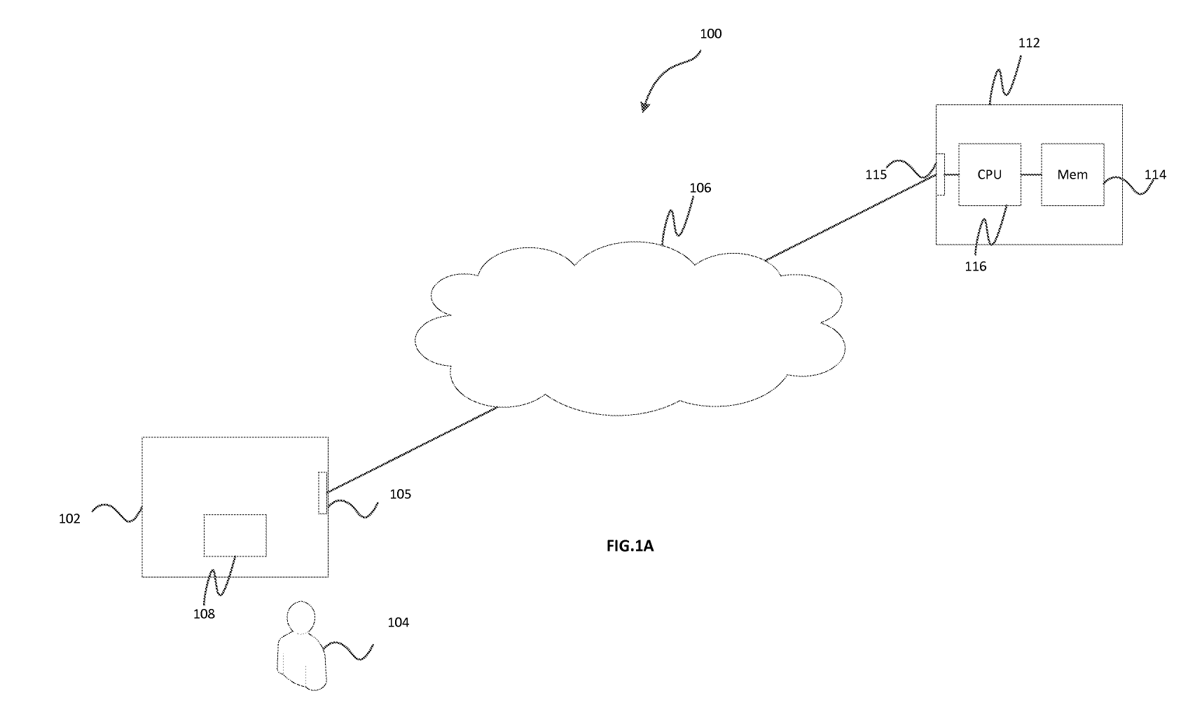

Reference is first made to FIG. 1, which illustrates a communication system 100. A user 104 of the communication system operates a user device 102, which is shown connected to a communication network 106. The communication network 106 may be for example the Internet. The user device 102 may be, for example, a mobile phone, a personal digital assistant (“PDA”), a personal computer (“PC”) or tablet computer (including, for example, Windows™, Mac OS™ and Linux™ PCs), a gaming device or other embedded device able to connect to the communication network 106. The user device 102 is arranged to receive information from and output information to the user 104 of the device. The user device 102 is able to transmit data to, and receive data from, the communication network 106 using a network interface 105. The user device 102 is configured to execute a communication client application 108, provided by a software provider. The communication client application 108 is a software program executed on a local processor in the user device 102.

Whilst FIG. 1 shows the user device 102 being connected directly to the communication network 106, it will be appreciated that the user device 102 may connect to the communication network 106 via additional intermediate networks not shown in FIG. 1. For example, if the user device 102 is a mobile device, then it can connect to the communication network 106 via a cellular mobile network (not shown).

As shown in FIG. 1, connected to the communication network 106 is a network node 112. The network node 112 may be a server. The network node 112 comprises a central processing unit (“CPU”) 116 and memory 114. The network node 112 is able to transmit data to, and receive data from, the communication network 106 using a network interface 115.

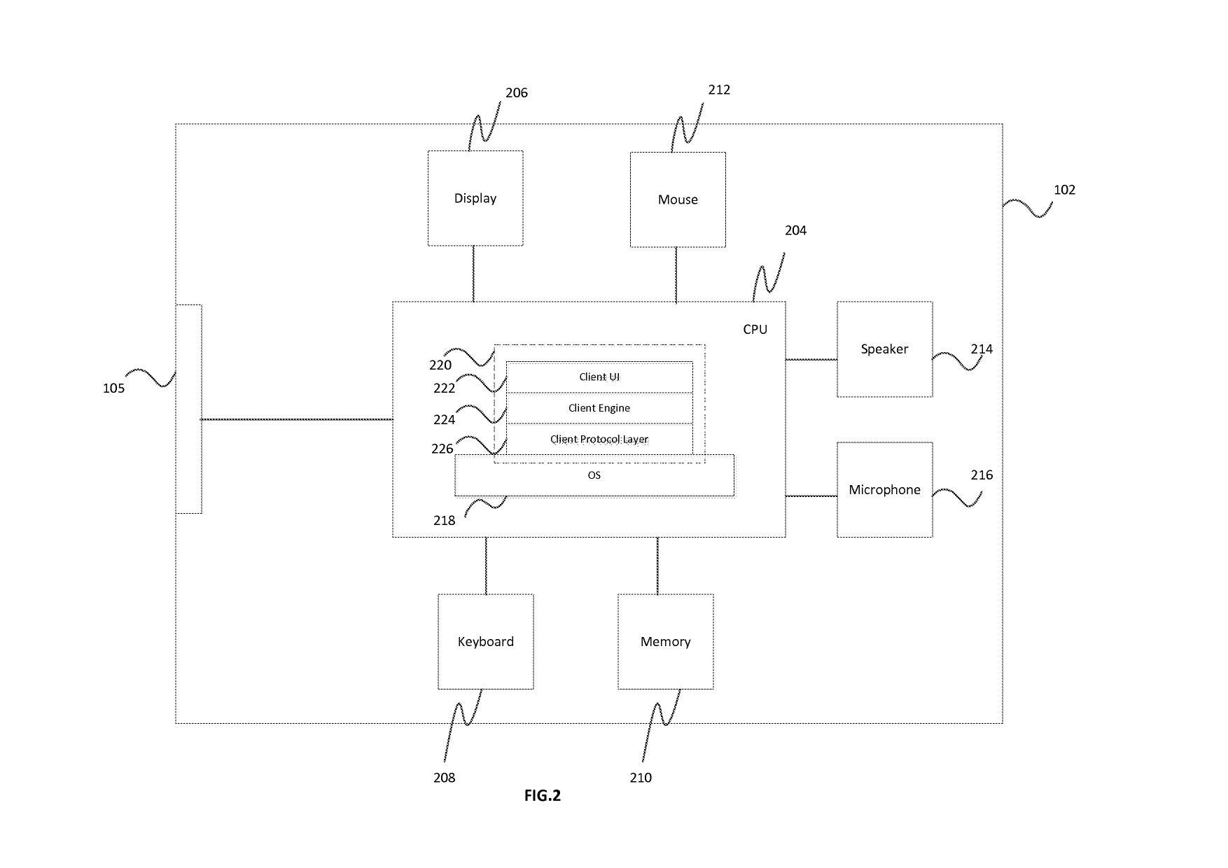

FIG. 2 illustrates a detailed view of the user device 102 on which is executed communication client application 108.

The user device 102 comprises a CPU 204. Connected to the CPU 204 is a display 206 and a speaker 214. The display 206 and speaker 214 are user interface components of the user device 102 which are used in embodiments of the invention to request from the user 104 entry of the account password and password simplifier. The display 206 is arranged to visually request from the user 104 entry of the account password and password simplifier, whilst the speaker 214 is arranged to audibly request from the user 104 entry of the account password and password simplifier.

Password information may be input using a variety of input devices of the user device 102. These input devices include for example the display 206 when the display 206 comprises a touch-screen for inputting data to the CPU 204. Other input devices include the keypad (or a keyboard) 208, a pointing device such as a mouse 212, and an input audio device 216 (e.g. a microphone). As shown in FIG. 2, all of the input devices 206, 208, 212, and 216 are connected to the CPU 204. Thus, CPU 204 is arranged to receive any password information input by the user 104 and is arranged to verify this password information as described in more detail herein.

The CPU 204 is connected to a network interface 105 such as a modem for communication with the communication network 106. The network interface 105 may be integrated into the user device 102 as shown in FIGS. 1 and 2. In alternative devices the network interface 105 is not integrated into the device 102. The user device 102 comprises a memory 210 for storing data. The memory 210 is configured such that data can be transferred between the CPU 204 and the memory 210 as is known in the art. The display 206, keypad 208, memory 210, mouse 212, speaker 214 and input audio device 216 are integrated into the user device 102. In alternative devices one or more of the display 206, the keypad 208, the memory 210, the mouse 212, the output audio device 214 and the input audio device 216 may not be integrated into the device and may be connected to the CPU 204 via respective interfaces. One example of such an interface is a USB interface.

FIG. 2 also illustrates an operating system (“OS”) 218 executed on the CPU 204. Running on top of the OS 218 is a software stack 220 for the communication client application 108. The software stack shows a client protocol layer 226, a client engine layer 224 and a client user interface layer (“UI”) 222. Each layer is responsible for specific functions. Because each layer usually communicates with two other layers, they are regarded as being arranged in a stack as shown in FIG. 2. The OS 218 manages the hardware resources of the device and handles data being transmitted to and from the communication network 106 via the network interface 105. The client protocol layer 226 of the client software communicates with the OS 218 and manages the connections over the communication system 100. Processes requiring higher level processing are passed to the client engine layer 224. The client engine 224 also communicates with the client user interface layer 222. The client engine 224 may be arranged to control the client user interface layer 222 to present information to the user via a user interface of the communication client application 108 and to receive information from the user via the user interface.

Once the user 104 has logged-in to the communication client application 108 using the username and account password (used to register an account with the software provider who provides the communication client application 108), a password simplifier is able to be configured.

The user may configure the account password and the password simplifier is automatically derived from the account password according to predetermined rules. That is, the communication client application 108 may derive a password simplifier from the account password based on certain rules. For example, when the account password consists of a number of characters the communication client application 108 may take the first and last character of the user's account password and set this as the user's password simplifier. In this example, if the user's account password is “ksjd79e9̂y” then the communication client application 108 would set the password simplifier as “ky” and the user 104 could use this password simplifier when the user subsequently logs-in to the communication client application 108. It will be apparent to those skilled in the art that various rules could be used to derive the password simplifier from the account password, and the example explained above merely serves to illustrate the concept.

The user may configure the account password and the password simplifier. To configure the password simplifier the user 104 may navigate one or more menus using the user interface of the communication client application 108 and set the password simplifier themself. For example if the user 104's username for the communication client application 108 is “someone”, then the user 104 may set the password simplifier to be “sm”.

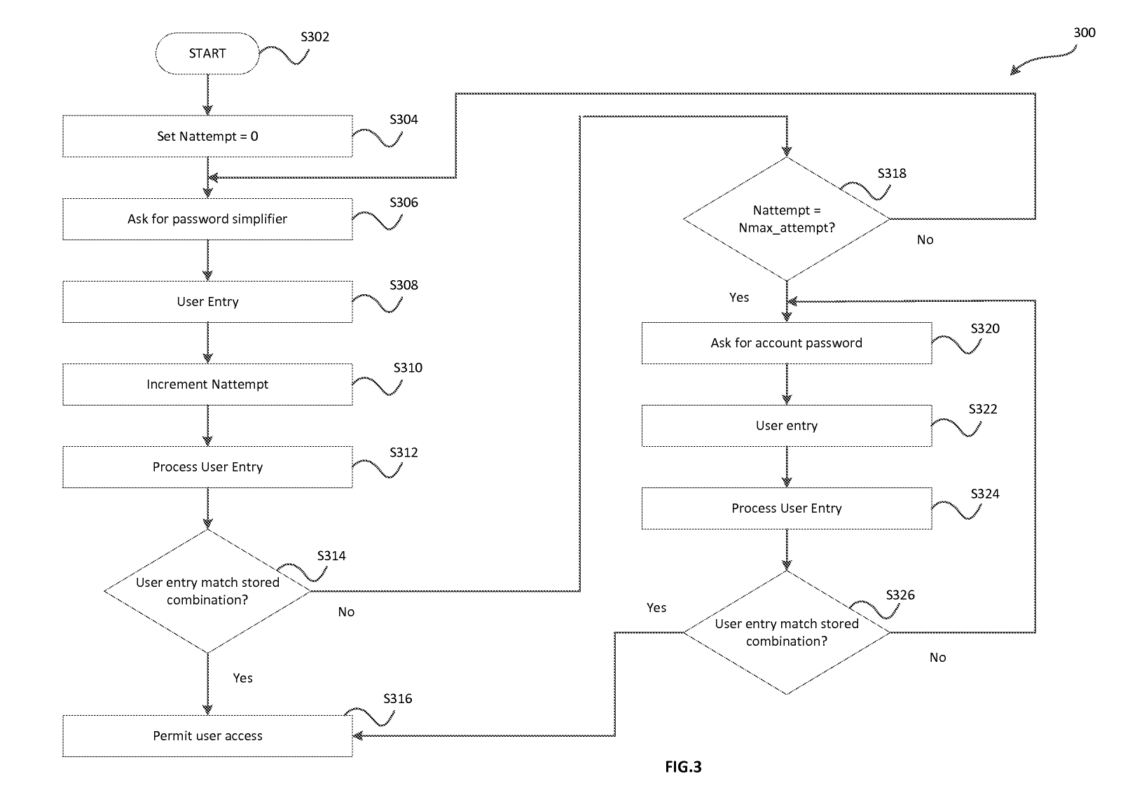

Once a password simplifier has been configured for user 104, for subsequent log-in attempts, the user 104 is able to enter the password simplifier to access the functionality of the communication client application 108. With reference to FIG. 3 there is now described a process 300 of permitting a user access to the communication client application 108.

The process 300 starts at step S302 when a user must enter a password to be permitted access to password protected data. At step S304 a parameter Nₐₜₜₑₘₚₜ is set to equal zero, the parameter Nₐₜₜₑₘₚₜ defines the number of times the user 104 has attempted to enter the password simplifier. The process then proceeds to step S306.

At step S306, a user interface component of the device requests that the user 104 enters their password simplifier. That is, the step S306 of requesting the password simplifier may comprise displaying on a display of the device a field in which the user is able to enter an attempt at the password simplifier. For example, the communication client application 108 may display a dialogue box on the display 206 via the user interface of the communication client application 108. The user 104 may be additionally requested to enter their username, however the communication client application 108 may retrieve the username from local memory 210 (from when the username was entered on a previous login). As will be apparent to those skilled in the art, entry of a username may not be required at all, and embodiments where a username is not required are discussed in more detail below.

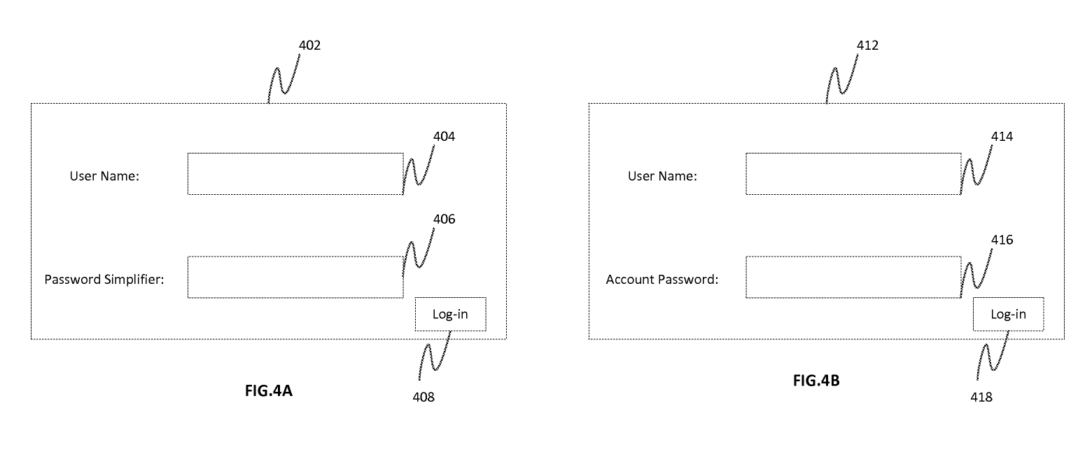

FIG. 4a shows an example dialogue box 402 that may be displayed at step S306. The dialogue box 402 comprises a username field 404 and a password simplifier field 406. The user 104 may move a pointer (not shown) in FIG. 4a over the fields 404,406, click into the fields 404,406 or otherwise activate the fields 404,406 (for example tab into the field using keyboard 208 or touch a touch-screen 206). This enables the user to enter the username and password simplifier. Once the username and password simplifier have been entered into fields 404 and 406 the user may select the log-in button 408. It will be appreciated that the dialogue box 402 may have less fields than that shown in FIG. 4a, for example when a user name is not required. Similarly the dialogue box 402 may have more fields than that shown in FIG. 4a, for example if the password protected data is information regarding a bank account one or more additional fields for the insertion of account information may be displayed.

It will be appreciated that the speaker 214 may implement step S306 by outputting an audible message requesting that the user enters their password simplifier

At step S308, the user attempts entry of their password simplifier. Depending on the form that the password simplifier takes the user may attempt entry of the password simplifier using one of the input devices 206, 208, 212, and 216. Once the user entry has been received at step S308, the process proceeds to step 310. At step S310 parameter Nₐₜₜₑₘₚₜ is incremented by one. Nₐₜₜₑₘₚₜ indicates how many times the user 104 has attempted to enter the password simplifier.

In the first embodiment, the account password and password simplifier associated with the user 104 are not stored in the memory 210 of the user device 102. Instead it is the network node 112 that stores the username, account password and password simplifier associated with the user 104 in memory 114. This enables the user 104 to login to the communication client application 108 using a variety of different devices.

The memory 114 may store an unencrypted representation of the account password and password simplifier (for example when the account password and password simplifier consists of a number of characters the memory 114 may store a plain text representation of the account password and password simplifier). Alternatively, the memory 114 may store an encrypted representation of the account password and password simplifier.

Following the increment of Nₐₜₜₑₘₚₜ, the process proceeds to step S312 where CPU 204 processes the user entry. In the first embodiment the CPU 204 implements step S312 by transmitting the username and password simplifier across the communication network 106 to the network node 112.

The CPU 116 at the network node 112 then compares the username and password simplifier received from the user device 102 with username and password simplifier combinations stored in memory 114. The CPU 116 then transmits an indication over the communication network 106 to the user device 102. The indication indicating whether the username and user entry matches a username and password simplifier combination stored in the memory 114 on the network node 112.

At step S314, the CPU 204 determines, based on the indication, if the username and password simplifier received from the user device 102 matches a username and password simplifier combination stored in memory 114.

If the CPU 204 determines, based on the indication, that the username and password simplifier received from the user device 102 matches a username and password simplifier combination stored in memory 114, the user 104 has correctly input their password simplifier and the process proceeds to step S316.

At step S316, the user 104 is permitted access to the functionality of the communication client application 108. For example, the user 104 is able access information such as profile information and contact lists and access functionality of the client software including voice calling, video calling, multimedia calling, instant messaging (“IM”), voicemail and file transfer.

If the CPU 204 determines, based on the indication, that the username and password simplifier received from the user device 102 does not match a username and password simplifier combination stored in memory 114, the user 104 has incorrectly input their password simplifier and the process proceeds to step S318.

At step S318, the parameter Nₐₜₜₑₘₚₜ is compared to a threshold value Nₘₐₓ_{_{—}}ₐₜₜₑₘₚₜ. The threshold value Nₘₐₓ_{_{—}}ₐₜₜₑₘₚₜ defines the number of attempts at entry of the password simplifier that the user 104 is permitted. Nₘₐₓ_{_{—}}ₐₜₜₑₘₚₜ is an integer value greater than zero. The user 104 may be permitted only a single attempt at entry of the password simplifier (i.e. Nₘₐₓ_{_{—}}ₐₜₜₑₘₚₜ=1).

If Nₐₜₜₑₘₚₜ does not equal Nₘₐₓ_{_{—}}ₐₜₜₑₘₚₜ (i.e. Nₐₜₜₑₘₚₜ<Nₘₐₓ_{_{—}}ₐₜₜₑₘₚₜ) then the process proceeds back to step S306 where the user 104 is given another attempt at entering the password simplifier.

If Nₐₜₜₑₘₚₜ does equal Nₘₐₓ_{_{—}}ₐₜₜₑₘₚₜ then the process proceeds to step S320. At step S320 a user interface component of the device requests that the user 104 enters their account password. The step S320 of requesting the account password may comprise displaying on a display of the device a field in which the user is able to enter an attempt at the account password. For example, the communication client application 108 may display a dialogue box on the display 206 via the user interface of the communication client application 108.

FIG. 4b shows an example dialogue box 412 that may be displayed at step S320. The dialogue box 412 comprises a username field 414 and an account password field 416. The user 104 may access and enter data in the fields 414,416 in the same manner as described above with reference to dialogue box 402 shown in FIG. 4a. The communication client application 108 may insert, in the username field 414, the same username that was entered into the username field 404 at step S308 (in this scenario the user 104 would only be required to enter the account password). Alternatively the user 104 may be required to enter both the username in field 414 and the account password in field 416. Once the username and account password have been entered into fields 414 and 416 the user may select the log-in button 418. It will be appreciated that the dialogue box 412 may have less fields than that shown in FIG. 4b, for example when a user name is not required. Similarly the dialogue box 412 may have more fields than that shown in FIG. 4b, for example if the password protected data is information regarding a bank account one or more additional fields for the insertion of account information may be displayed.

It will be appreciated that the speaker 214 may implement step S320 by outputting an audible message requesting that the user enters their account password. Once the user 104 has entered a username and account password at step S322, the process proceeds to step S312 where CPU 204 processes the user entry. In the first embodiment the CPU 204 implements step S312 by transmitting the username and account password across the communication network 106 to the network node 112. The CPU 116 at the network node 112 then compares the username and account password received from the user device 102 with username and account password combinations stored in memory 114. The CPU 116 then transmits an indication over the communication network 106 to the user device 102. The indication indicating whether the username and user entry matches a username and account password combination stored in the memory 114 on the network node 112.

At step S326, the CPU 204 determines, based on the indication, if the username and account password received from the user device 102 matches a username and account password combination stored in memory 114.

If the CPU 204 determines, based on the indication, that the username and account password received from the user device 102 matches a username and account password combination stored in memory 114, then the user 104 has correctly input their account password and the process proceeds to step S316. At step S316, the user 104 is permitted access to the functionality of the communication client application 108 as described above.

If the CPU 204 determines, based on the indication, that the username and account password received from the user device 102 does not match a username and account password combination stored in memory 114, then the user 104 has incorrectly input their account password and the process proceeds back to step S320.

The user may be permitted a predetermined number of attempts at entry of the account password and if the user entry does not match the second password in the predetermined number of attempts the user is prevented access to the password protected data. That is, whilst FIG. 3 shows that the user 104 may be given an unlimited number of attempts at entry of the account password (see loop of steps S320, S322, S324 and S326), FIG. 3 may include an additional step (not shown in FIG. 3) which limits the number of attempts at entry of the account password given to the user 104 after which, if the user entry does not match the account password, the user's account is blocked and the user must contact the software provider who provides the communication client application 108 to activate the account and allow further log-in attempts.

At some point in time after the user 104 is permitted access to the functionality of the communication client application 108 at step S316, the user 104 will be logged out of the communication client application 108. This may be a result of the user 104 manually logging out of the communication client application 108, or termination of the execution of the communication client application 108. When the user 104 wants to subsequently log-in to the communication client application 108, the process 300 will start again at step S302.

It will be apparent that in the first embodiment the log-in sequence to access the client communication application 108 can be significantly shortened when the user 104 successfully enters their password simplifier, thereby improving the user experience. The password simplifier provides similar protection to the account password given that the user is only permitted one or very few attempts at entering the password simplifier. Furthermore the account password and password simplifier are not stored locally on the device 102 thereby reducing the risk of unauthorized access to the client communication application 108. Finally, it will be apparent to those skilled in the art that communication client application 108 is able to easily implement the process 300 shown in FIG. 3.

As described above the methods described herein can be applied to any system in which a user must enter a password to access data.

In one embodiment, the password protected data is data of a website accessed on the device 102. In this embodiment, the user 104 registers a username and account password with the website provider. The website provider may derive a password simplifier from the account password based on certain rules or alternatively the user 104 may set up the password simplifier themself (once logged into the website using the account password). Thus the user 104 is associated with two passwords, the account password and the password simplifier. In this embodiment the website provider stores the username, account password and password simplifier associated with the user 104 in memory 114 of the network node 112 i.e. in memory external to the device 102, thus the user. The process 300 of permitting the user 104 access to the website may be implemented by the website provider via the website as described above with respect to the first embodiment. It will be apparent that the advantages described above in relation to the first embodiment are also applicable to this embodiment.

As described above the methods described herein can be applied to any system in which a user must enter a password to access data.

In other embodiments, the user device 102 stores the username, account password and password simplifier associated with the user 104 in memory 210 of the device. When the account password and password simplifier are stored in a storage means on the device, the steps of processing the user entries (steps 312,324) with the password simplifier and account password may comprise comparing the user entries with the account password and password simplifier stored in the storage means on the device.

For example, in one embodiment, the password protected data is data of the operating system 218 executed on the processor 204 of the device. It is common for operating systems to enable multiple accounts to be set-up to enable different users to access the operating system. Single-user operating systems are usable by a single user at a time. When an operating system account is configured by a user, the user is associated with a username and account password. The operating system 218 may derive a password simplifier from the account password based on certain rules or alternatively the user 104 may set up the password simplifier themself (once logged into the operating system using the account password). Thus the user 104 is associated with two passwords, the account password and the password simplifier, and the process 300 of permitting the user 104 access to the operating system 218 may be implemented by the operating system 218. In this embodiment once the user has entered a username and password simplifier (at step S308) the CPU 204 compares, at step S312, the username and password simplifier received from the user device 102 with username and password simplifier combinations stored in local memory 210. Similarly, when the user 104 enters a username and account password (at step S320) the processor 204 compares, at step S324, the username and account password received from the user device 102 with username and account password combinations stored in local memory 210.

The operating system 218 may retrieve the username from local memory 210 (from when the username was entered on a previous login) such that a username is not required to be entered, and only a password simplifier or account password must be entered by the user 104.

Some operating system systems can be enabled to be “locked” after a period of inactivity (when no input is received from a user in a specified time period). When the operating system is “locked” a user cannot access the functionality of the operating system. Typically, the operating system 218 retrieves the username from local memory 210 (from when the username was entered on the prior login) and automatically inserts the username into a username field of a dialogue box that is displayed on a screen of the device. To unlock the operating system a user must enter the account password in an account password field of the dialogue box displayed on a screen of the device. When the operating system is “unlocked” a user can access the functionality of the operating system 218. The operating system 218 may associate a user with two passwords, the account password and the password simplifier, and implement the process 300 to allow a user access to the operating system 218 when the operating system 218 has been locked.

It will be apparent that in this embodiment the log-in sequence to access the operating system can be significantly shortened when the user 104 successfully enters their password simplifier, thereby improving the user experience. The password simplifier provides similar protection to the account password given that the user is only permitted one or very few attempts at entering the password simplifier. Finally, it will be apparent to those skilled in the art that operating system 218 is able to easily implement the process 300 shown in FIG. 3.

It will be appreciated that the above implementations, are just some of the ways the methods described herein may be implemented. Further implementations will be apparent to those skilled in the art for example, permitting a user access to data stored in a computer file, folder or directory in an operating system, permitting a user access to data stored on a hardware device for example a storage medium, and permitting a user access to data of an email client program executed on a device.

Whilst the above embodiments have been exemplified with reference to an account password and password simplifier which consist of a number of characters, it will be appreciated that this is just one example form which the account password and password simplifier can take.

The account password may take the form of a string of characters as described above.

The account password may take the form of a stored voice print i.e. a recording of the user 104's voice recorded using the microphone 216. When the account password takes the form of a stored voice print, the user interface component of the device requests that the user 104 speaks into the microphone 216 to enter the account password.

The account password may also take the form of a number of interactions with a picture displayed on the display 206, referred hereinafter as a picture password. That is, the user 104 may set an account password by selecting a picture and interacting with the picture by drawing one or more of a circle, a straight line or tapping a portion of the picture. For example, the account password may be configured with a photograph of a person's face and the user 104 drawing a line between the person's eyes, drawing a circle around the person's nose and tapping the person's mouth. It will be appreciated that these interactions are merely examples to illustrate how the picture password may be configured. The user may interact with the picture by touching the touchscreen 206 of the device 102, or using a mouse 212 to draw the shapes. When the account password takes the form of a picture password, the user interface component of the device displays the picture and requests that the user 104 interacts with the picture to enter their account password.

The account password may take the form of a pattern between points displayed on the display 206. The user 104 is able to enter the account password by touching the touchscreen 206 of the device 102 and drawing a pattern between the displayed points. When the account password takes the form of a pattern between points displayed on the display 206, the user interface component of the device displays the points and requests that the user 104 interacts with the displayed points to enter their account password. In embodiments when the device 102 is a mobile phone, such an account password may be used by a user to configure a “screen lock” to prevent unauthorised access to data on the mobile phone. The user must enter the account password to “unlock” and gain access to the data on the mobile phone. It will be apparent that such. In these embodiments, entry of a username to access the password protected data on the mobile phone is not required.

The password simplifier may also take these alternative forms described above in relation to the account password.

In some embodiments, the password simplifier and the account password are of the same format. For example, when the account password takes the form of a stored voice print i.e. a phrase or sentence recorded by the user 104 using the microphone 216, the password simplifier also takes the form of a voice print i.e. a word taken from the phrase or sentence recorded by the user 104 using the microphone 216. In another example, when the account password takes the form of three interactions with a picture displayed on the display 206 (picture password), the password simplifier may also be a picture password but only require a single interaction with the picture displayed on the display 206. In yet another example, when the account password takes the form of a pattern between four points displayed on the display 206, the password simplifier may also take the form of a pattern between points but may be a pattern between two points displayed on the display 206 i.e. the password simplifier pattern is between less points displayed on the display 206 than the account password pattern. These examples are merely to illustrate the concept and are not intended to be limiting in any way.

In other embodiments, the password simplifier and the account password are of different formats. In all embodiments, entry of the password simplifier provides a simpler and quicker way for a user to access password protected data compared to entry of the account password.

As explained above, the use of the term “password” herein should not be limited to a word or a string of characters but is intended to cover other formats that an input may take to access protected data.

Users may feel a level of insecurity when offered to use a password simplifier. This feature can be deemed optional for the user.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of permitting a user access to password protected data at a device, the user associated with a first password and a second password, the first and second password being of the same format, the method comprising:
requesting from the user, at a user interface component of the device, entry of the first password;
in response to receiving an entry by the user, determining if the user entry matches the first password associated with the user in a password verifying component of the device;
responsive to a positive determination, permitting the user to access to the password protected data, the password verifying component permitting a predetermined number of attempts at entry of the first password and if no user entry matches the first password in the predetermined number of attempts, the method further comprising:
requesting from the user, at the user interface component of the device, entry of the second password;
in response to receiving a new entry by the user, determining if the new entry matches the second password associated with the user; and
responsive to a determination that the new entry matches the second password associated with the user, permitting the user access to the password protected data, entry of the first password requiring fewer user input actions than are required for entry of the second password.

2. The method of claim 1, wherein the user is permitted a single attempt at entry of the first password.

3. The method of claim 1, wherein the first password and the second password each consist of a number of characters, the second password having more characters than the first password.

4. The method of claim 3, wherein the number of characters of the first password is equal to or less than three.

5. The method of claim 3, wherein number of characters of the second password is equal to or greater than six.

6. The method of claim 3, wherein the characters of the first and second password include one or more of: one or more lower case letters, one or more upper case letters, one or more numbers, or one or more symbols.

7. The method of claim 1, wherein the user interface component of the device comprises a display, and the first password and the second password each consist of a number of interactions with a picture displayed on said display.

8. The method of claim 1, wherein the first and second password each consist of a voice print, and wherein the user attempts entry of the first and second password using an audio input of the device.

9. The method of claim 1, wherein the user configures the first and second password.

10. The method of claim 1, wherein the user configures the second password and the first password is automatically derived from the second password according to predetermined rules.

11. The method of claim 1, wherein the password verifying component permits a predetermined number of attempts at entry of the second password, and the predetermined number of attempts at entry of the first password is less than the predetermined number of attempts at entry of the second password.

12. The method of claim 1, wherein the password verifying component permits a predetermined number of attempts at entry of the second password and if the user entry does not match the second password in the predetermined number of attempts the user is prevented access to the password protected data.

13. The method of claim 1, wherein the user interface component is a display, the display requesting from the user entry of the first password by displaying a first field in which the user is able to enter an attempt at the first password, and the display requesting from the user entry of the second password by displaying a second field in which the user is able to enter an attempt at the second password.

14. The method of claim 1, wherein the first password and second password are stored in a storage memory on said device,
determining if the user entry matches the first password associated with the user comprises the password verifying component comparing the user entry with the first password stored in said storage memory; and
determining if the new entry matches the second password associated with the user comprises the password verifying component comparing the new entry with the second password stored in said storage memory.

15. The method of claim 1, wherein the first password and second password are stored in a storage memory on a network node, the network node connected to the device via a communication network,
determining if the user entry matches the first password associated with the user comprises the password verifying component transmitting the user entry from the device over the communication network to a processing unit on said network node, and receiving an indication from said processing unit as to whether the user entry matches the first password stored in the storage memory on the network node; and
determining if the new entry matches the second password associated with the user comprises the password verifying component transmitting the new entry from the device over the communication network to a processing unit on said network node, and receiving an indication from said processing unit as to whether the new entry matches the second password stored in the storage memory on the network node.

16. The method of claim 1, wherein the password protected data is data of:
an operating system executed on a processor of said device.

17. The method of claim 1, wherein the password protected data is data of a website accessed on said device.

18. The method of claim 1, wherein the password protected data is data of an application executed on a processor of said device.

19. A computer program product for permitting a user access to password protected data at a device, the user associated with a first password and a second password, wherein the first and second password are of the same format, the program product comprising code embodied on a computer-readable storage medium, the code executable by one or more processors to perform operations comprising:
requesting from the user, at a user interface component of the device, entry of the first password;
in response to receiving an entry by the user, determining if the user entry matches the first password associated with the user;
responsive to a positive determination, permitting the user access to the password protected data, a predetermined number of attempts at entry of the first password being permitted and if no user entry matches the first password in the predetermined number of attempts, the code is further executable to perform:
requesting from the user, at the user interface component of the device, entry of the second password;
in response to receiving a new entry entered by the user, determining if the new entry matches the second password associated with the user; and
responsive to a determination that the new entry matches the second password associated with the user, permitting the user access to the password protected data, entry of the first password requiring fewer user input actions than are required for entry of the second password.

20. A device arranged to permit a user access to password protected data at the device, the user associated with a first password and a second password, the user device comprising a user interface component and a password verifying component, the device performing operations comprising:
requesting from the user, at a user interface component of the device, entry of the first password;
in response to receiving an entry by the user, determining if the user entry matches the first password associated with the user in a password verifying component of the device;
responsive to a positive determination, permitting the user to access to the password protected data, the password verifying component permitting a predetermined number of attempts at entry of the first password and if no user entry matches the first password in the predetermined number of attempts, the operations further comprising:
requesting from the user, at the user interface component of the device, entry of the second password;
in response to receiving a new entry by the user, determining if the new entry matches the second password associated with the user; and
responsive to a determination that the new entry matches the second password associated with the user, permitting the user access to the password protected data, entry of the first password requiring fewer user input actions than are required for entry of the second password.
